(19) United States
(12) Patent Application Publication
(10) Pub. No.: US 2010/0213180 A1
(43) Pub. Date: Aug. 26, 2010

(54) Jig for a laser engraving machine and method of use

(75) Inventor: Michael D. Miller, Dalton, OH (US)

Correspondence Address: SAND & SEBOLT, AEGIS TOWER, SUITE 1100, 4940 MUNSON STREET, NW, CANTON, OH, 44718-3615, US

(73) Assignee: Ulazer, LLC, Dalton, OH (US)

(21) Appl. No.: 12/378,847

(22) Filed: Feb. 20, 2009

(51) Int. Cl. B23K 26/38

(52) U.S. Cl. 219/121.69; 219/121.68

(57) ABSTRACT

A jig is disclosed for properly positioning an article to be engraved by a laser engraving machine along with a method of using the jig and machine. The jig includes a light source that projects beams of light onto an article to be engraved. The light beams typically intersect and thereby indicate the correct location for the article to be positioned for engraving. A retaining device is provided to engage the article and hold it in the proper place during engraving.

### BACKGROUND OF THE INVENTION

1. Technical Field

This invention generally relates to engraving equipment. More particularly, the invention relates to a jig for a laser engraving machine and a method of using the same. Specifically, the invention relates to a jig for an engraving machine that includes alignment lights and retaining members that assist an operator in correctly positioning an article to be engraved in the machine.

2. Background Information

Engraving is performed by cutting an image into an exterior surface of an article. Historically, engravers used specially shaped metal tools or the like to carve the desired letters, shapes or images into articles. Today, laser engraving machines are more commonplace for producing engravings although they are rather expensive. Most of these machines utilize computer programs to direct the engraving head on the machine during the production of the image.

Despite various advances, the machine operators often have problems in correctly positioning and retaining the articles to be engraved relative to the engraving head during engraving. This is especially true in the case of irregularly shaped objects. Laser engraving machines present a particular problem in that the cutting device used to engrave letters or other images is formed of laser beams. Thus, unlike solid engraving tools which can be positioned very close to an article to be engraved in order to verify the actual engraving location on the article without actually performing the engraving, a laser beam cannot be positioned adjacent the article for this purpose without actually turning the laser beam on, which will automatically result in the laser beam cutting into the article whether or not the article is properly aligned.

There is therefore a need in the industry for a device and a method for properly positioning and retaining articles to be engraved by a laser engraving machine.

### SUMMARY OF THE INVENTION

The present invention provides a method comprising the steps of: placing an article on an article support on a laser engraving machine; activating a light source to project a point of reference alignment indicator formed of light on the article; positioning the article at an aligned position in which the alignment indicator is projected at a selected engraving location on the article; and engraving the article at the engraving location with a laser-emitting device of the laser engraving machine.

The present invention also provides a jig for positioning an article to be engraved by a laser engraving machine, said jig comprising: an article support adapted to support the article during engraving of the article; and a light source having an activated state in which the light source projects a point of reference alignment indicator formed of light on the article support whereby the light source is adapted to project the alignment indicator on the article at a selected engraving location of the article.

The present invention further provides a laser engraving machine comprising: a housing; an article support within the housing adapted for supporting thereon an article to be engraved; a light source having an activated state in which the light source projects a point of reference alignment indicator formed of light on the article support whereby the light source is adapted to project the alignment indicator on the article at a selected engraving location of the article; and a laser-emitting engraving device movably mounted on the housing and adapted for laser engraving the article at the engraving location.

### BRIEF DESCRIPTION OF THE DRAWINGS

The preferred embodiments of the invention, illustrative of the best mode in which applicant has contemplated applying the principles, are set forth in the following description and are shown in the drawings and are particularly and distinctly pointed out and set forth in the appended claims.

FIG. 1 is a perspective view of a jig mounted in a laser engraving machine in accordance with the present invention;

FIG. 2 is a perspective view of the jig removed from the laser engraving machine;

FIG. 3 is a sectional top view of the jig of FIG. 2.

FIG. 4 is a perspective view of the jig with the alignment lights on and an object to be engraved placed in the jig but not being retained therein.

FIG. 5 is a perspective view of the jig with the clamps engaging the object to be engraved and thereby retaining the same in the correct position for engraving.

FIG. 6 is a sectional top view of the jig and object shown in FIG. 5.

FIG. 7 is a cross-sectional front view of the jig and object taken through line 7-7 of FIG. 6.

FIG. 8 is an exploded perspective view of the jig with the crossbar with the alignment lights thereon detached from the base of the jig.

FIG. 9 is a perspective view of the base of the jig mounted in an upper portion of the engraving machine and showing the object being engraved.

FIG. 10 is an exploded perspective view of the jig showing a tray filled with a sticky substrate retained in grooves on the upper surface of the base.

FIG. 11 is a perspective view of the jig with an irregularly shaped object retained by the sticky substrate in the tray and showing the alignment lights on the irregularly shaped object indicating that the object is in the correct position for engraving.

### DETAILED DESCRIPTION OF THE INVENTION

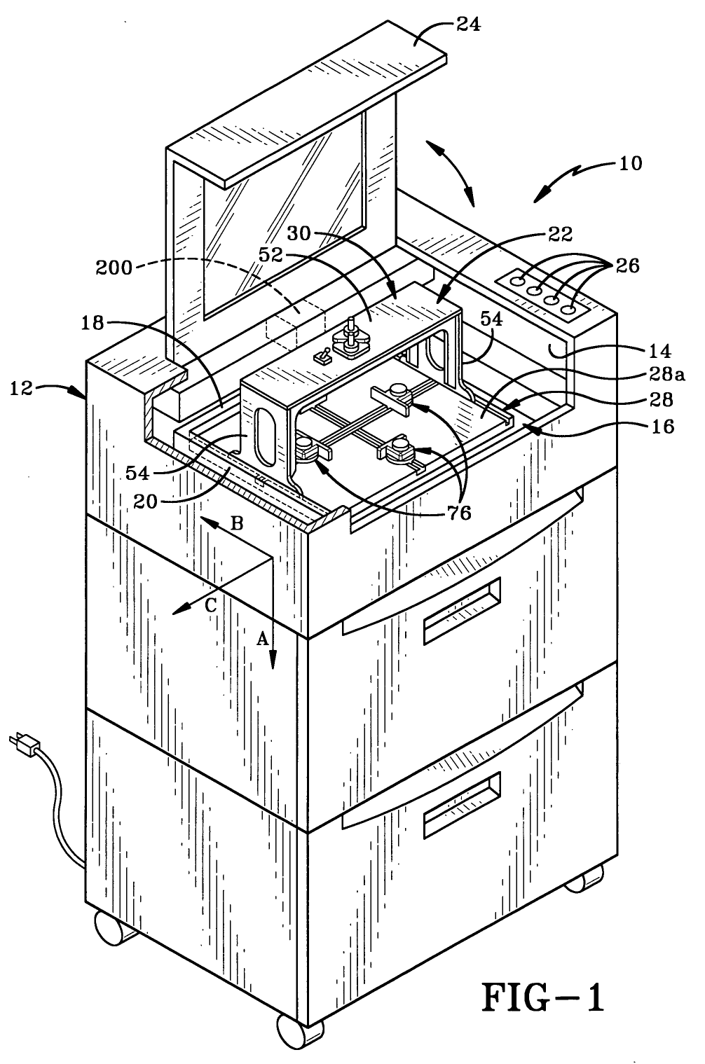

Referring to FIGS. 1-11, there is shown an engraving machine in accordance with the present invention and generally indicated at 10. Engraving machine 10 includes a housing 12 defining a chamber 14 in which is disposed a vertically adjustable table 16 which is typically flat and substantially horizontal. Typically, a rear fence 18 (FIGS. 1 & 9) and a left fence 20 are secured to and extend upwardly from table 16 to guide or position a jig 22 that is disposed thereon. It will be understood that table 16 may also or alternately include a right fence and/or a front fence.

Machine 10 has an elevator mechanism to move table 16 with jig 22 thereon upwardly and downwardly. The machine 10 is also provided with a cover 24 that is movable between an open position (FIG. 1) and a closed position (not shown). Cover 24 is moved into the open position in order to insert and position jig 22 on table 16 and to gain access to jig 22. In the exemplary embodiment, jig 22 is removably mounted on table 16. In order to use jig 22 as a retrofit device with laser engraving machine 10, cover 24 is opened and jig 22 is inserted into chamber 14 via the entrance opening created by the opening of cover 24 to position jig 22 atop table 16. More particularly, jig 22 is lowered (Arrow A) onto table 16, and then moved rearwardly (Arrow B) into abutment with the front face of fence 18 and to the left (Arrow C) into abutment with left fence 20. Fences 18 and 20 thus provide an alignment device for aligning jig 22 with various components of machine 10, including table 16 and a laser engraving head 200, which is movable relative to table 16 forward, backward, to the left and to the right under computer control. Head 200 includes a laser-emitting device for producing laser beams used to engrave various types of articles. Cover 24 is moved into the closed position before engraving begins. A plurality of activation buttons 26 is provided on housing 22 to operate machine 10.

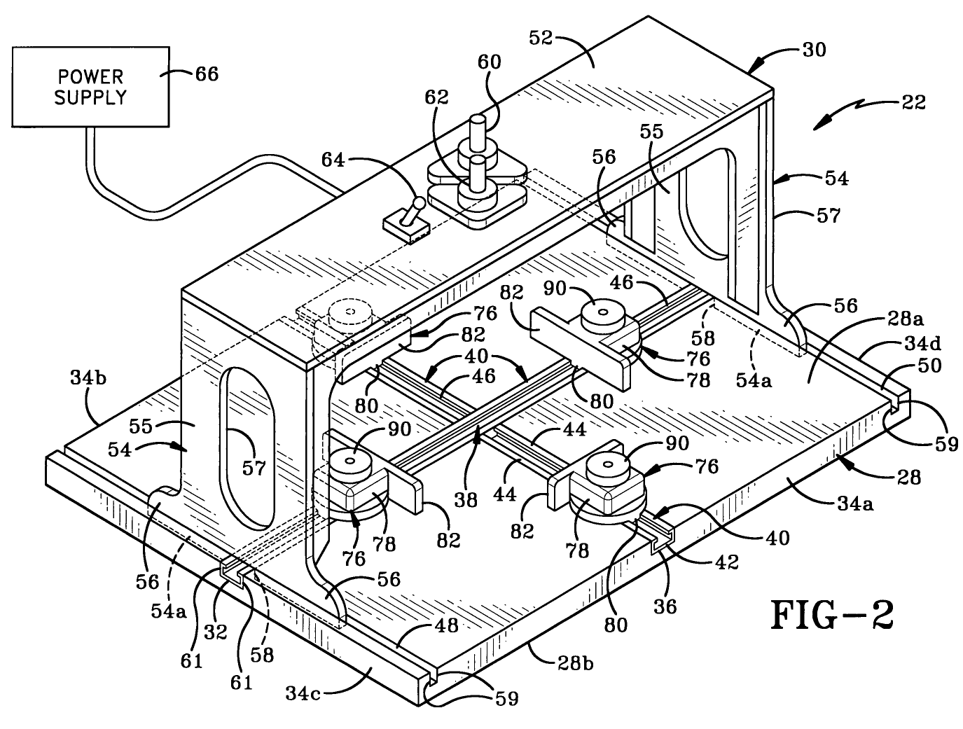

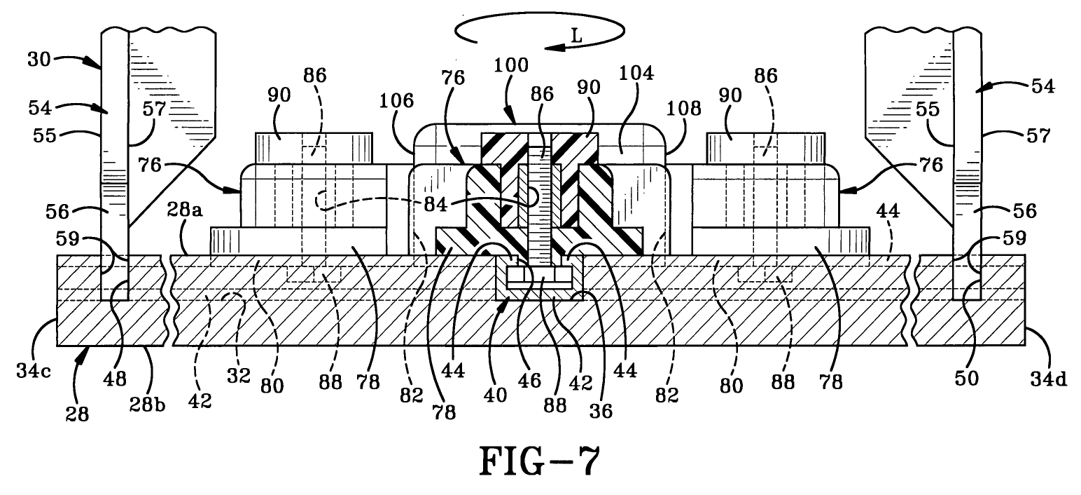

FIGS. 2-11 show jig 22 in greater detail. Jig 22 comprises an article support or base 28 and a light support 30. Base 28 has an upper surface 28a and a lower surface 28b (FIG. 7) that is disposed in abutting contact with the upper surface of table 16 when seated thereon. A pair of horizontal orthogonal slots is formed in upper surface 28a. A longitudinally elongated first slot 32 is oriented substantially parallel to a front edge 34a and rear edge 34b of table 16. First slot 32 preferably is disposed equidistant from front and rear edges 34a, 34b. An axially elongated second slot 36 is oriented substantially parallel to side edges 34c, 34d. Second slot 36 preferably is disposed equidistant from side edges 34c, 34d. First and second slots 32, 36 intersect each other substantially in the center 38 of base 28. Each of the first and second slots 32, 36 is provided with a C-shaped channel member 40 (FIG. 7) that is seated in the respective slot. Each channel member 40 has a floor 42 and a pair of opposing lips 44 that extend inwardly toward one another from respective sidewalls to terminal edges that are separated from each other by a gap 46. Base 28 further includes end slots 48, 50 defined proximate side edges 34c, 34d, respectively. Axially elongated end slots 48, 50 are oriented substantially parallel to side edges 34c, 34d. Each end slot 48, 50 intersects first slot 32 adjacent the opposed ends of first slot 32.

As previously noted, jig 22 when used with machine 10 is positioned atop table 16 in abutment with perpendicular fences 18 and 20. More particularly, rear edge 34b of base 28 is positioned parallel to and in contact with the front surface of rear fence 18 while left edge 34c is positioned parallel to and in contact with the right face of left fence 20 when base 28 is seated atop table 16 in order to properly align jig 22 with table 16 and the other components of machine 10 including engraving head 200. In the exemplary embodiment, center 38 of base 28 is typically aligned directly below a starting position of engraving head 200 or in a known predetermined position relative to a correspondingly known predetermined position of head 200. The aligned position of base 28 likewise aligns light support 30 with reference to the various components of machine 10 such that an article to be engraved by engraving head 200 is positioned correctly as will be discussed further below.

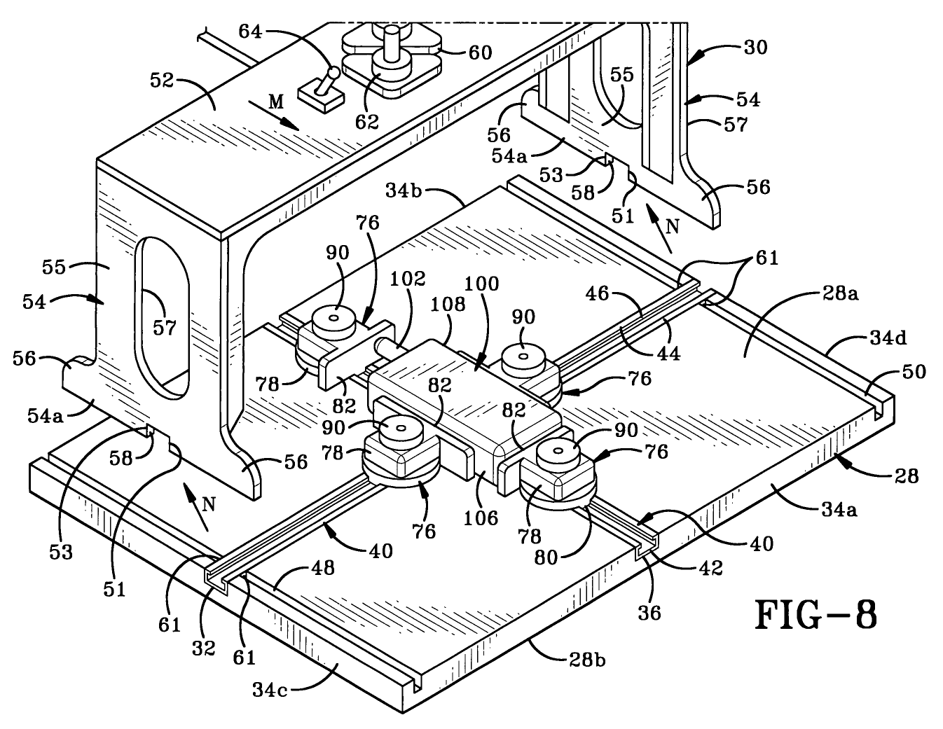

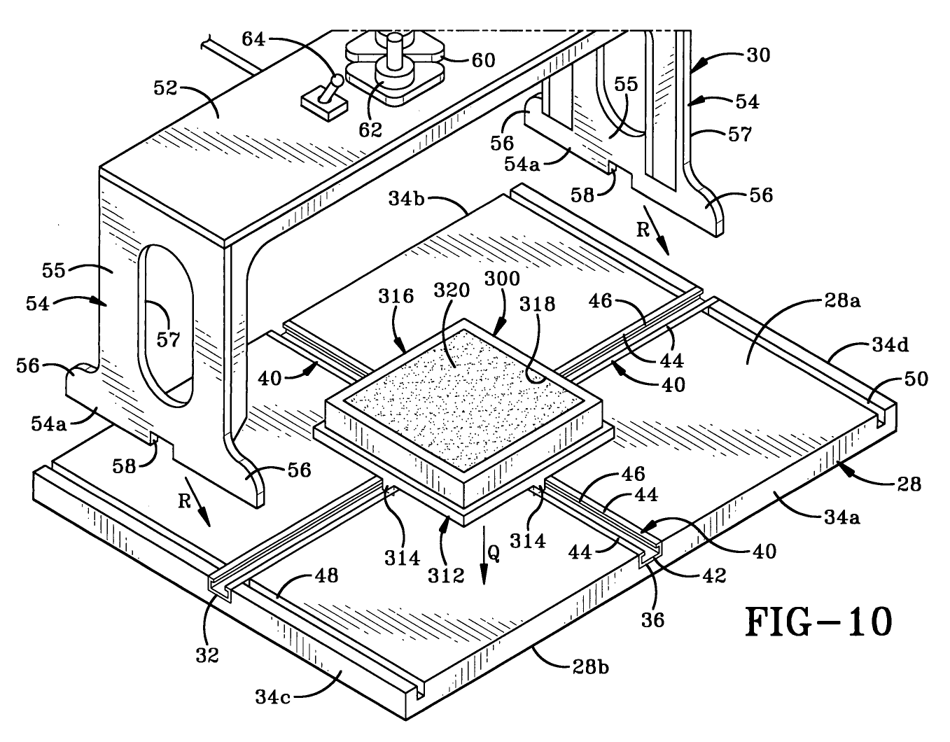

Light support 30 is detachably interlockingly engaged with base 28 and includes a crossbar 52 and a pair of legs 54 that extend downwardly away from crossbar 52. The lower end 54a of each leg is provided with a pair of flanges 56 that extend outwardly from the end 54a and in opposite directions to each other. The free end 54a and flanges 56 have left and right vertical surfaces or sides 55 and 57 defining therebetween a thickness that is substantially equal to although slightly less than the width of end slots 48, 50. The free end 54a of each leg 54 is also provided with a notch 58 (FIGS. 8, 10) that is complementary in size and shape to the cross-sectional shape of channel members 40. Notch 58 is typically provided substantially in the center of free end 54a and is bounded by vertical front and rear edges 51 and 53 (FIG. 8). Light support 30 engages base 28 by inserting the free end 54a of each leg 54 into one of end slots 48, 50. The notch 58 of each leg 54 is positioned over a portion of channel member 40 so that member 40 is received in notch 58.

When support 30 is mounted or seated atop base 28, the axially elongated vertical surfaces defining each end slot 48, 50 serve as stops 59 which engage the axially elongated vertical surfaces or sides 55 and 57 of the respective lower end 54a inserted therein to prevent or substantially eliminate longitudinal movement of support 30 relative to base 28. Likewise, the axially spaced opposed front and rear sides of the sidewalls of channel member 40 in slot 32 serve as stops 61 which engage the axially spaced edges 51 and 53 bounding each notch 58 to prevent or substantially eliminate axial movement of support 30 relative to base 28. Thus, the positioning of light support 30 on base 28 such that the lower ends 54a of legs 54 are received respectively in notches 48 and 50 with the channel 40 within slot 32 being received in notches 58 ensures that light support 30 is properly aligned with base 28. In the exemplary embodiment, support 30 may be mounted on and dismounted from base 28 simply by respectively lowering support 30 into position and raising it to separate it from base 28. Thus, there are typically no latches, locks or securing devices which must be latched and unlatched, locked and unlocked, or secured and unsecured to mount and dismount support 30 on base 28.

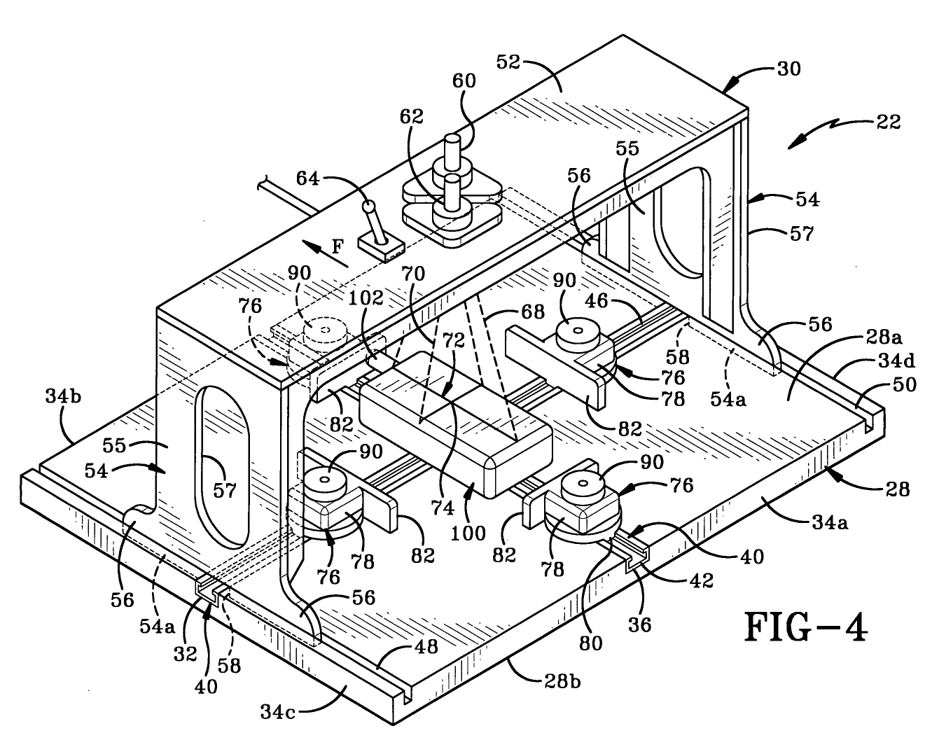

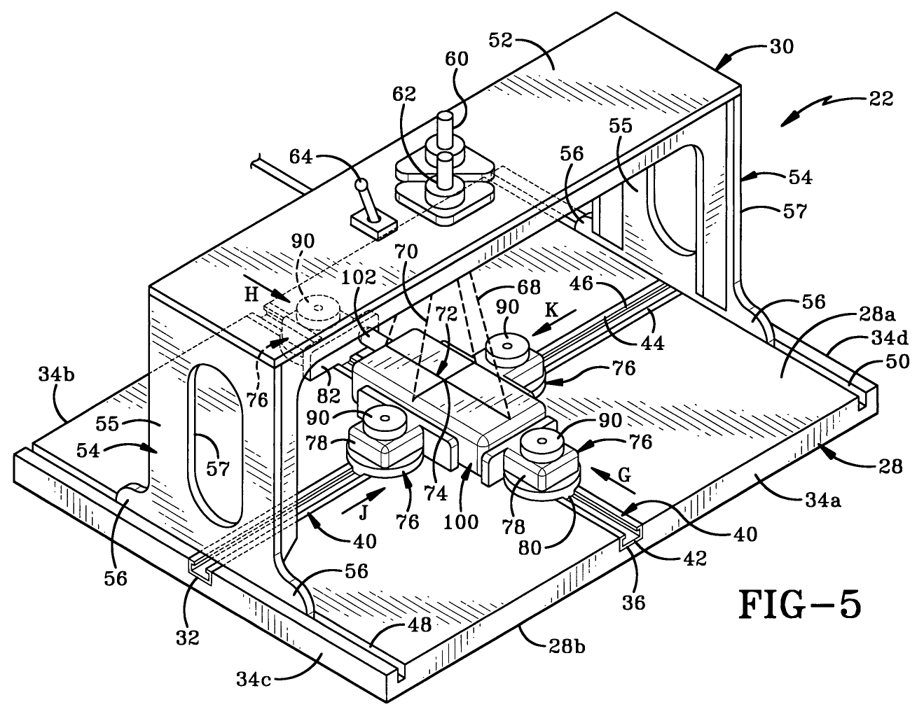

Crossbar 52 of light support 30 is provided with a light source in the form of a pair of alignment lights 60, 62. A single on/off switch 64 is operationally connected to both lights 60, 62. Switch 64 and lights 60, 62 are electrically connected to a remote power supply 66. Each light 60, 62 is configured when activated to project a beam of light 68, 70 (FIGS. 4, 5) downwardly from a bottom surface of crossbar 52 and onto upper surface 28a of base 28 or on an object positioned atop base 28. It is noted that the beams 68 and 70 are formed of light which is not capable of engraving upper surface 28a or an object positioned atop base 28, nor are these beams of light capable of injuring a person's hands when shone thereon. Thus, any light which may be suitably focused into beams to form an alignment indicator without engraving the article or otherwise causing damage as noted is suitable for this purpose. For instance, any standard lights which can be focused in this manner such as incandescent lights, fluorescent lights, halogen lights and so forth. In the exemplary embodiment, light source 60, 62 uses light emitting diodes (LEDs) which can be easily focused and require very little energy to operate. The light source may use low power laser beams as long as they do not cause engraving to occur or subject a user to injury.

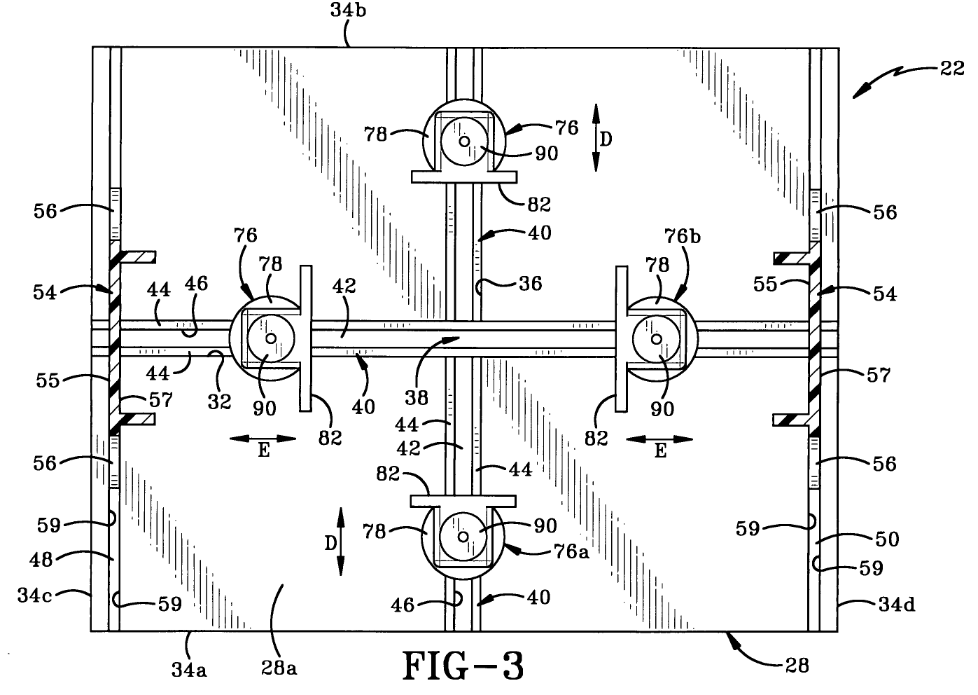

The beams 68, 70 typically intersect each other and thereby form cross-hairs 72 of light on upper surface 28a of base 28 or an object thereon. In the exemplary embodiment, the two beams 68, 70 intersect each other at a centerpoint 74 which is aligned with the center 38 (FIGS. 2, 3) of upper surface 28a of base 28. The use of cross-hairs 72 provides a point of reference alignment indicator formed of light which is easily understood when viewed by the operator. However, the alignment indicator does not have to be formed of light beams which intersect. For instance, the light source could focus light beams to produce a single relatively small dot of light to serve as a point of reference alignment indicator. By way of further example, light beams could form a central dot with a pair of longitudinal lines on either side of the central dot and a pair of axial lines on opposite sides of the central dot in order to highlight the central dot as the point of reference. Alternately, beams of light could be formed to provide a longitudinal line and an axial line which nearly intersect, but do not actually intersect on the upper surface of the base 28 or an article disposed thereon. Thus, various options are available although cross-hairs 72 are a very convenient configuration for providing the point of reference alignment indicator.

As noted above, center point 74 of cross-hairs 72 is vertically aligned with center 38 on base 28. This is ensured by the proper positioning of light support 30 on base 28 with the bottom of legs 54 in slots 48 and 50 as previously discussed. Thus, when jig 22 is positioned atop table 16 abutting fences 18 and 20 as previously described, lights 60 and 62 are appropriately positioned to produce at the correct location center point 74 or a similar point of reference alignment indicator which serves to indicate typically where engraving head 200 will begin engraving an article properly positioned on jig 22. However, although center point 74 may not indicate where engraving head 200 will begin engraving an article, it will indicate a reference point within a region which will be engraved by engraving head 200 so that an article can be properly aligned prior to the engraving procedure. The proper alignment of base 28 on table 16 and the proper positioning of light support 30 atop base 28 thus properly positions lights 60 and 62 to produce the alignment indicator made of light such as cross-hairs 72 so that center point 74 or the like provides a proper point of reference relative to machine 10 and in particular relative to engraving head 200.

Jig 22 further includes a plurality of retaining members 76 for retaining or securing an article 78 to be engraved on jig 22. Each retaining member 76 comprises a base member 78 having a pair of tabs or detents 80 extending downwardly away from a bottom surface thereof. Detents 80 are configured to be received through gap 46 in channel members 40 and to extend downwardly toward floor 42 thereof. Each detent 80 is nearly as wide as gap 46 so that the detent is in contact with or closely adjacent the terminal ends of lips 44 of the given channel 40 whereby the engagement between detent 80 and lips 44 serves as a stop to rotational movement of base member 78 about a vertical axis. Base member 78 further includes a planar article-engaging face 82 that is typically oriented so as to be substantially at right angles to the upper surface 28a of base 28. A vertically oriented aperture 84 is defined in base member 76. An externally threaded securement pin 86 extends through aperture 84 and is provided with an enlarged foot 88 at a bottom end thereof and an enlarged internally threaded nut or head 90 at a top end thereof which threadedly engages pin 86. Each retaining member 76 is engaged in one of the first and second slots 32, 36 of base 28 in such a manner that the foot 88 on pin 86 is disposed in channel member 40 between the floor 42 and lips 44 thereof. Pin 86 extends upwardly through gap 46 between lips 44 and thus head 90 is disposed above upper surface 28a of base 28. The planar faces 82 of the four retaining members 76 are oriented so that they are proximate and facing the center 38 of base 28. Thus, the planar faces 82 of the left and right retaining members 76 in first slot 32 are opposed to and face each other, and the planar faces 82 of the front and rear retaining members 86 in second slot 36 are opposed to and face each other.

Each retaining member 76 is configured to be able to slide back and forth in the respective one of the first and second slots 32, 36 with detents 80 slidably engaging the terminal edges of the respective lips 44. This sliding motion occurs between the edge of base 28 and the center 38 thereof. So, for example, retaining member 76a (FIG. 3) is able to slide back and forth in the forward and rearward directions (Arrows D) between front edge 34a and center 38, while retaining member 76b (FIG. 3) is able to slide back and forth in the left and right directions (Arrows E) between side edge 34d and center 38. This sliding motion is only possible when the retaining member 76 is not in a locked condition, that is, when nut or head 90 is sufficiently loosened. As shown in FIG. 3, the planar article engaging surfaces 82 of the left and right retaining members 76 are parallel to one another and extend in the axial direction. The planar surfaces 82 of the front and back retaining members 76 are parallel to one another and extend in the longitudinal direction, and are thus perpendicular to the surfaces 82 of the left and right retaining members 76. The relative orientations of the various article engaging surfaces 82 is maintained at all times even during the sliding movement of the retaining members back and forth within their respective slots due to the use of detents 80, which as previously noted extend downwardly into the respective gaps 46 and the channel members and prevent rotation of the respective base members 78 about a vertical axis. Although someone may wish to engrave certain articles which are irregularly shaped and do not have parallel sides or a straight side, the use of the retaining members 78 with the planar surfaces as described above is especially useful in helping to align articles which do have one or more relatively straight surfaces along one side when they are seated atop base 28. However, it may be desired under certain circumstances for the article engaging surfaces to be positioned at different angles or to be rotatable about a vertical axis in order to more appropriately engage certain surfaces of a given article to be engraved.

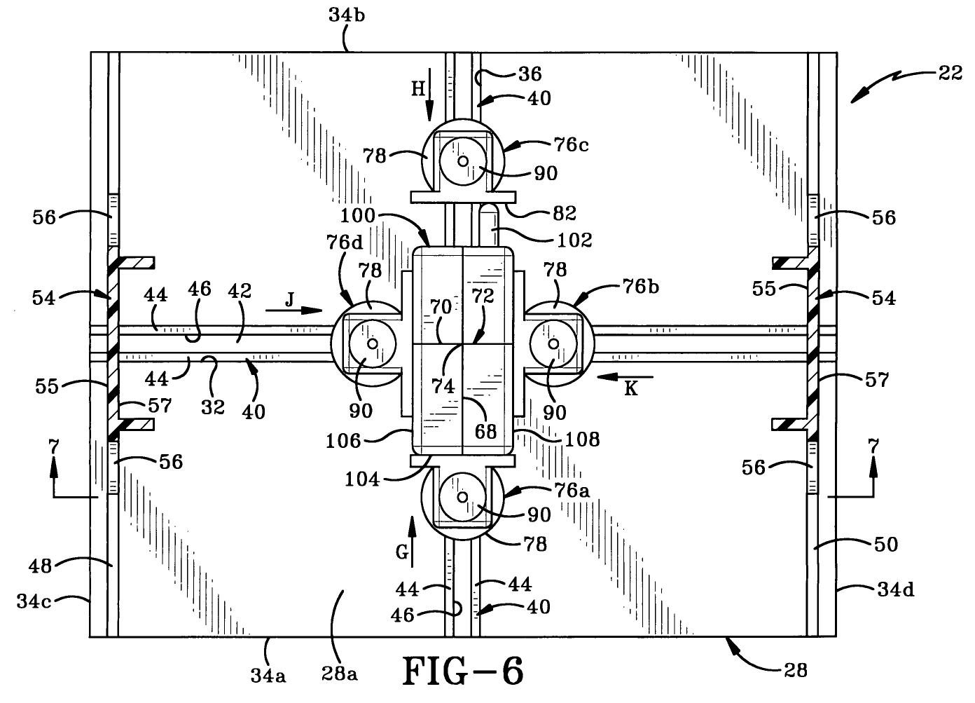

Referring to FIGS. 4-9, the engraving machine 10 in accordance with the present invention is used in the following manner. Cover 24 is opened so that the user can gain access to jig 22. Switch 64 is moved (Arrow F in FIG. 4) from an “off” position (FIG. 2) to an “on” position (FIG. 4) to activate alignment lights 60, 62 to emit light beams 68, 70 thereby forming a cross-hair 72 or other point of reference alignment indicator on upper surface 28a. An article 100 to be engraved, such as a cell phone, is placed onto the upper surface 28a of base 28 and is positioned such that at least a portion of an engraving location of article 100 is disposed at the centerpoint 74 of cross-hair 72. The operator then manipulates retaining members 76 into engagement with article 100. This requires sliding of each retaining member 76 from the location illustrated in FIG. 4 in which faces 82 are out of contact with article 100 toward article 100 and the centerpoint 74 of cross-hair 72. In order to slide each retaining member 76, it is first loosened, released or unlocked. If a retaining member 76 cannot be slidingly moved along channel member 40 because it is in its secured position, the operator need only grasp head 90 of retaining member 76 and rotate it in a first loosening or unthreading direction that lowers foot 90 to sufficiently release the clamping of lips 44 between foot 90 and the lower surface of the main portion of base member 78. Each retaining member 76 is slid inwardly (Arrows G, H, J, K) toward center 38 and centerpoint 74 until the planar face 82 thereof comes into contact with a portion of the exterior surface of article 100. The operator may have to move each separate retaining member 76, which operate independently of one another, to a greater or lesser degree toward the centerpoint 74 depending on the shape of the exterior of article 100. So, for example, as shown in FIG. 6, retaining member 76a is moved (Arrow G) further inwardly toward the centerpoint 74 (or other reference point) than is retaining member 76c (Arrow H) because the antenna 102 on article 100 projects further outwardly away from centerpoint 74 (or other reference point) than does the end wall 104 of article 100. Retaining members 76b, 76d are substantially equidistant from centerpoint 74 because the side walls 106, 108 of article 100 are equidistant from centerpoint 74.

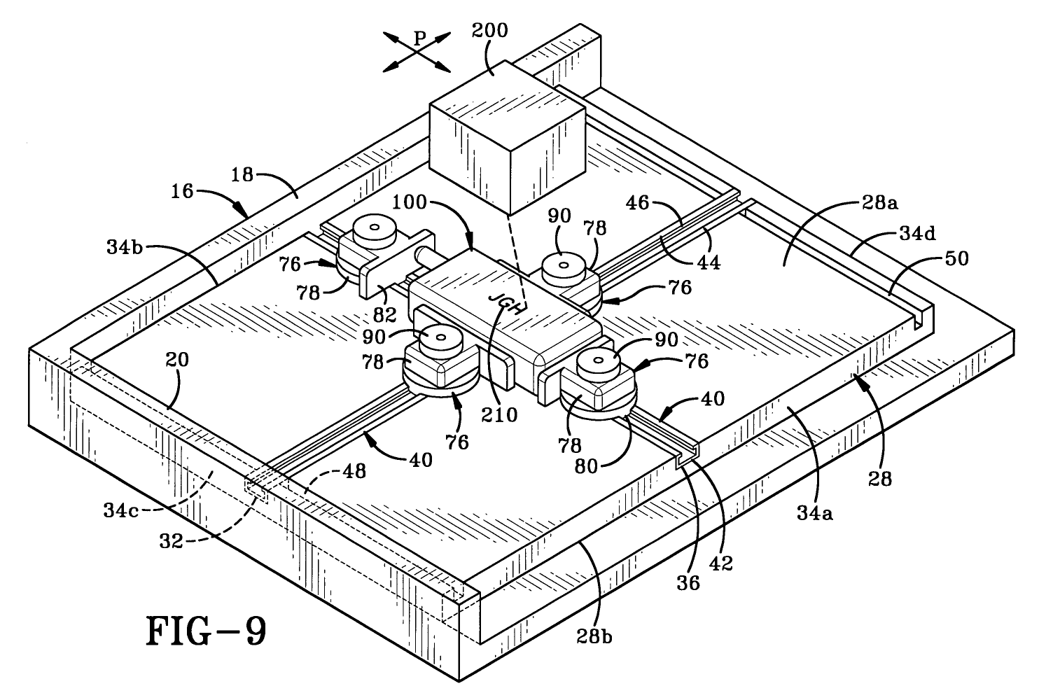

When the centerpoint 74 of cross-hair 72 is positioned over the desired portion of the engraving location of article 100, such as the center of article 100, the retaining members 76 are secured in place. In order to do this, the operator grasps head 90 on retaining member 76 and rotates it (Arrows L in FIG. 7) in a second tightening or securing direction that will cause foot 88 to advance upwardly into a secure contact with lips 44 of channel member 40. When all four retaining members 76 are fully secured in place, article 100 is disposed between and engaged by the planar faces 82 thereof to prevent lateral or horizontal movement in any direction so as to maintain article 100 in an engraving position (FIGS. 8, 9). Switch 64 is moved (Arrow M in FIG. 8) from the “on” position to the “off” position. At this point, light support 30 is detached from base 28 and is moved (Arrows N in FIG. 8) out of the way so that engraving head 200 (FIGS. 1, 9) of machine 10 may be brought into position to engrave the article 100. In the exemplary embodiment, light support 30 and light sources 60, 62 are thus in an interfering position when seated atop base 28 such that they would interfere with movement of engraving head 200. Thus, light support 30 and light source 60, 62 are moved to a non-interfering position where they will not interfere with movement of engraving head 200 in order to allow head 200 to perform the engraving of article 100.

Engraving machine 10 can then be activated to engrave the article 100. Cover 24 (FIG. 1) is moved into a closed position and the operator depresses the appropriate buttons 26 on housing 12. The engraving head of machine 10, illustrated in FIG. 9 by the block 200, is brought into the proximity of article 100 under computer control and is caused to engrave the desired characters 210 onto article 100 by various longitudinal and axial movement (Arrow P in FIG. 9). As previously mentioned, machine 10 may cause table 16 to be raised or lowered as necessary to perform the engraving operation. When the article 100 has been fully engraved, the operator depresses buttons 26 on housing 12 and deactivates the machine 10. The operator may then disengage each retaining member 76 by grasping the head 90 thereof and rotating the same about a central axis in the loosening direction to cause the foot 88 to be lowered. When retaining members 76 are sufficiently loosened and generally no longer clampingly engaged to lips 44 of the associated channel member 40, the retaining members 76 may be slid along the respective one of first and second slots 32, 36 and away from article 100. Article 100 may then be removed from machine 10. Depending on the specific configuration of positioning members 76, article 100 may be removed from the engraving position without loosening positioning members 76 or sliding them away from article 100. For example, where planar faces 82 are vertically oriented and include no overhanging portions extending directly over article 100, faces 82 may not preclude vertical movement of article 100, which can thus simply be lifted vertically while members 76 remain secured in their respective retaining positions.

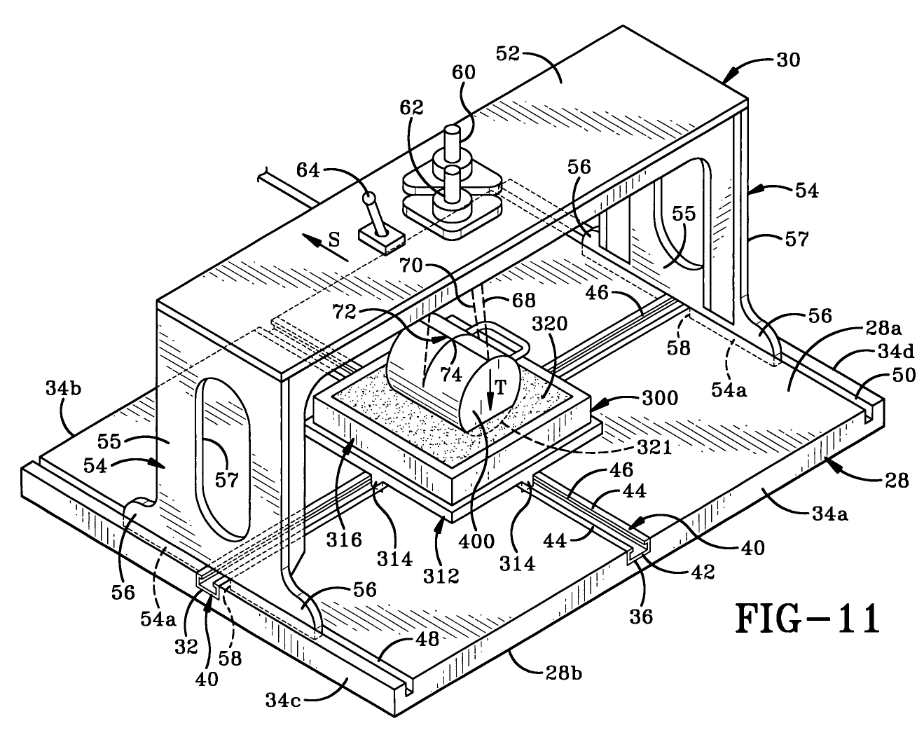

FIGS. 10 and 11 show another configuration and method of positioning an article 400 for engraving. Article 400 may be irregularly shaped and usually is of a type that has an exterior shape that is not easily retained on base 28 by planar faces 82 of retaining members 76. However, the apparatus and method of FIGS. 10 and 11 may also be used with any type of article, such as article 100. A tray 300 is provided to receive article 400 and hold it in an appropriate position for engraving. Tray 3d0 typically has a square base member 312 that has four tabs or detents 314 extending downwardly from a bottom surface thereof. Detents 314 are positioned on tray 300 so that they will each extend downwardly into one of the first and second slots 32, 36. Tray 300 further includes a perimeter wall 316 that extends upwardly and outwardly away from base member 312. Perimeter wall 316 and base member 312 define an open top interior cavity 318 that has a depth substantially equal to the height of the perimeter wall 316. A typically sticky or tacky substance 320 is retained within cavity 318. A suitable type of substance 320 is a plastic type of modeling compound. As shown in FIG. 11, a portion of article 400 is pressed or pushed into substance 320 to form a cavity or depression 321 having a shape complementary to the portion of article 400 displacing substance 320. Substance 320 firmly holds article 400 in a set position but can be easily removed from article 400 when it is engraved.

As noted above, substance 320 is typically a sticky or tacky substance and in the exemplary embodiment is a plastically deformable substance such as a modeling compound. For instance, PLAY-DOH® modeling compound may be used as substance 320. However, other suitable modeling compounds may be used, such as a modeling compound that dries out very slowly or does not dry out in standard atmospheric conditions. When a modeling compound is used as substance 320 in the present invention, it should be formed of a pliable material which can be depressed by hand and be “plastically deformable” which is defined herein as being deformable in response to a deforming stress such that the substance remains deformed after the deforming stress is removed. Most plastically deformable modeling compounds are sticky or tacky to some degree although some of these compounds may exhibit little if any tackiness. Compounds exhibiting little or no tackiness may also be used as substance 320 in the present invention inasmuch as pressing an article into such a substance may still allow it to remain in the desired engraving position. Preferably, substance 320 allows for the removal of an engraved article therefrom without leaving a residue on the article or leaving only a minimal residue thereon. If substance 320 does leave a residue on the engraved article on its removal, the operator may clean it off with a suitable cloth or the like which may also include the use of a preferably mild solvent or cleaner if necessary.

Tray 300 is used in the following manner. Tray 300 is lowered (Arrow Q in FIG. 10) into engagement with base 28 to insert its four detents 314 respectively into gaps 46 of first and second slots 32, 36. Detents 314 are nearly as wide as gaps 46 whereby the terminal edges of lips 44 serve as stops engaged by detents 314 to eliminate the axial and longitudinal movement of tray 300 relative to base 28. Detents 314 thus properly align tray 300 and substance 320 relative to base 28, lights 60 and 62 and the various components of machine 10 when jig 22 is properly aligned atop table 16. In the exemplary embodiment, tray 300 may be respectively mounted on and removed from base 28 by respectively vertically lowering tray 300 so that detents 314 enter the appropriate gaps 46 and vertically raising tray 300 out of contact with base 28. Thus, in the exemplary embodiment, there are no fastening mechanisms or the like which secure tray 300 to base 28 such that they must be unfastened to remove tray 300. Light support 30 is engaged with base 28 by lowering (Arrows R in FIG. 10) free ends 54a and flanges 56 into end slots 48, 50 so that notch 58 is received over channel member 40. Light switch 64 is moved (Arrow S in FIG. 11) into the “on” position so that cross-hairs 72 are projected onto substance 320, tray 300 and/or article 400. Article 400 is moved, by the operator, over substance 320 so that cross-hairs 72 fall generally in a selected engraving region or location of article 400. Article 400 is then lowered onto substance 320 and the operator pushes downwardly (Arrow T in FIG. 11) on article 400 to force at least a portion thereof into substance 320. The operator checks that the appropriate portion or point of the engraving location or region of article 400 is in the correct position under the centerpoint 74 of cross-hairs 72 and makes any adjustments that are necessary to properly position article 400. Light support 30 is then detached from base 28 as previously discussed and is moved out of the way so that the engraving head 200 can be used to engrave article 400. Once the engraving of article 400 is completed, article 400 is removed from substance 320 at which time any residue remaining on article 400 may be cleaned off. Substance 300 can be manually manipulated due to its plastically deformable quality in order to prepare substance 320 for insertion of another article to be engraved if desired. Preferably, substance 320 is reusable to retain many articles one after another and thus can be deformed multiple times in any suitable fashion in order to retain said articles.

It is noted that FIG. 11 does not show retaining members 76 or shows that retaining members 76 have been removed from first and second slots 32, 36. It is not necessary to remove the same and the retaining members 76 may be slid into contact with tray 300 to hold tray 300 in place on base 28, for instance if tray 300 were formed without detents 314 or another mechanism to hold it in place on base 28. On the other hand, jig 22 may be set up to use tray 300 and substance 320 to retain a given article to be engraved without using the retaining members 76. Furthermore, it is contemplated that tray 300 may be formed of any various shape other than square and also may be formed without perimeter wall 316 inasmuch as substance 320 may simply be seated atop a flat tray which does not define a cavity such as that circumscribed by perimeter wall 316. Furthermore, jig 22 may be formed without the use of a tray such as tray 300 such that substance 320 is positioned directly atop the article support 28. Substance 320, if it has sufficient tackiness, may thus simply be adhered via that tackiness to the upper surface 28a of base 28 in the location where light beams 68 and 70 shine to create the point of reference. Alternately, base 28 may be formed with an upwardly open cavity in which substance is disposed without the use of a separate tray such as tray 300. Alternately, a tray such as tray 300 may be secured in a non-removable fashion on base 28.

While the present invention has been described primarily as a jig which is used as a retrofit with a laser engraving machine 10, the invention nonetheless includes a laser engraving machine which utilizes a light source such as lights 60 and 62 which are positioned to create the appropriate point of reference alignment indicator on an article positioned atop table 16 or the like in order to facilitate the proper positioning of an article to be engraved. Thus, the various components described with reference to jig 22 may be incorporated directly into a laser engraving machine such as machine 10.

In the foregoing description, certain terms have been used for brevity, clearness, and understanding. No unnecessary limitations are to be implied therefrom beyond the requirement of the prior art because such terms are used for descriptive purposes and are intended to be broadly construed. Moreover, the description and illustration of the invention are an example and the invention is not limited to the exact details shown or described.

1. A method comprising the steps of:
placing an article on an article support on a laser engraving machine;
activating a light source to project a point of reference alignment indicator formed of light on the article;
positioning the article at an aligned position in which the alignment indicator is projected at a selected engraving location on the article; and
engraving the article at the engraving location with a laser-emitting device of the laser engraving machine.

2. The method of claim 1 wherein the step of activating comprises the step of activating the light source to project cross-hairs formed of light on the article.

3. The method of claim 1 lowering the article support onto a table of the laser engraving machine; and moving the article support into abutment with at least one alignment fence extending upwardly of the table in order to align the article support at a predetermined position.

4. The method of claim 1 detaching from the article support a light support on which the light source is mounted.

5. The method of claim 1 prior to the step of activating, setting on the article support a light support on which the light source is mounted so that the light support engages at least one stop on the article support to prevent the light support from moving laterally relative to the article support.

6. The method of claim 1 wherein the light source has an interfering position and a non-interfering position such that the light source at the interfering position would interfere with movement of the laser-emitting device during the step of engraving and the light source at the non-interfering position does not interfere with movement of the laser-emitting device during the step of engraving; the step of activating comprises the step of activating the light source to project the alignment indicator on the article while the light source is at the interfering position; and further comprising the step of moving the light source to the non-interfering position after the step of positioning and before the step of engraving.

7. The method of claim 1 engaging the article with a retaining device to retain the article at the aligned position during the step of engraving.

8. The method of claim 7 wherein the step of engaging comprises the step of moving a first retaining member relative to the article support.

9. The method of claim 8 wherein the step of engaging comprises the step of moving the first retaining member relative to the article support from a first disengaged position out of contact with the article to a first engaged position in contact with the article.

10. The method of claim 9 securing the first retaining member to the article support at the engaged position.

11. The method of claim 9 wherein the step of engaging comprises the step of moving a second retaining member relative to the article support from a second disengaged position out of contact with the article to a second engaged position in contact with the article.

12. The method of claim 8 wherein the step of moving comprises the step of moving the first retaining member relative to the article support so that the first retaining member slidably engages the article support.

13. The method of claim 12 wherein the step of moving comprises the step of sliding a portion of the first retaining member within an elongated slot formed in the article support.

14. The method of claim 7 wherein the step of engaging comprises the step of pressing a portion of the article into a plastically deformable substance so that the substance is plastically deformed by the portion of the article.

15. The method of claim 14 wherein the step of pressing comprises the step of pressing the portion of the article into a modeling compound.

16. The method of claim 14 mounting a tray carrying the plastically deformable substance atop the article support.

17. The method of claim 7 wherein the step of engaging comprises the step of engaging the article with a tacky substance.

18. The method of claim 1 mounting a tray atop the article support so that the tray supports the article at the aligned position.

19. A jig for positioning an article to be engraved by a laser engraving machine, said jig comprising:
an article support adapted to support the article during engraving of the article; and
a light source having an activated state in which the light source projects a point of reference alignment indicator formed of light on the article support whereby the light source is adapted to project the alignment indicator on the article at a selected engraving location of the article.

20. A laser engraving machine comprising:
a housing;
an article support within the housing adapted for supporting thereon an article to be engraved;
a light source having an activated state in which the light source projects a point of reference alignment indicator formed of light on the article support whereby the light source is adapted to project the alignment indicator on the article at a selected engraving location of the article; and
a laser-emitting engraving device movably mounted on the housing and adapted for laser engraving the article at the engraving location.
